(19) United States
(12) Patent Application Publication
(10) Pub. No.: US 2003/0077409 A1
(43) Pub. Date: Apr. 24, 2003

(54) Composite structural element and method for producing the same

(76) Inventor: Stephan Schnell, Worms (DE)

Correspondence Address: Keil & Weinkauf, 1350 Connecticut Avenue NW, Washington, DC, 20036, US

(21) Appl. No.: 10/221,204

(22) PCT Filed: Mar. 22, 2001
(86) PCT No.: PCT/EP01/03261

(30) Foreign Application Priority Data
Mar. 24, 2000 (DE) 100 14 332.6

(51) Int. Cl. B32B 1/08

(52) U.S. Cl. 428/35.8; 264/259

(57) ABSTRACT

The invention relates to a composite component and to a process for its production. The composite component is composed of a hollow-profile base (1), which has a hollow-profile cross section and is advantageously produced by the HF process, and of at least one plastic element (2) which has been securely connected to the hollow-profile base (1). The plastic element (2) has been molded onto the hollow-profile base (1) and its connection to the hollow-profile base (1) takes place at discrete connection sites (3, 6) by partial or complete jacketing of the hollow-profile base (1) at the connection sites (3, 6, 6a, 6b, 10, 12) by the molded-on plastic for the plastic element (2).

The invention relates to a composite component composed of a base which has a tubular or closed-hollow-profile cross section, and of plastic elements which have been securely connected to the base, a process for the cost-effective production of the composite component, and also its use as a front-end module, tailgate door, door-function module, or seat component.

Composite components of this nature and of appropriate shape are used in automotive or vehicle construction, for example. The base and the plastic elements provide mutual stiffening and reinforcement. The plastic elements moreover serve for functional integration, involving the formation of a system or module. The composite components have hitherto been produced as separate components, and this implies relatively high manufacturing and assembly cost. In addition, the total weight of the separate components is generally higher than that of corresponding composite components. It has moreover been found that, given acceptable dimensioning of the cross sections, comparable components which are composed solely of plastic have lower strengths and stiffnesses, and also disadvantages in energy absorption on impact load when compared with components of the same type made from metallic material.

DE-19 728 052 A1 relates to a seat element with frame. This Offenlegungsschrift discloses a seat element, in particular a backrest for a vehicle seat, with a frame and with a body having a first surface and a second surface. This frame, ideally a tubular steel frame, has been completely surrounded by the body, and the body is a plastic molding composed of a plastic whose modulus of elasticity to ISO 527 is at least 500 MPa. The first and the second surface of the plastic molding have been distanced from one another by distancing elements, and connected to one another by the same, in particular using a force-fit method. The distancing elements are indentations in the first surface and an indentation in the second surface, foam fillings, rib structures, or spacers, or a combination of these means.

DE-A 1 956 826 discloses a lightweight plastic structural element. The lightweight plastic structural element has a reinforced corrugated plastic sheet laminated within a U-shaped upper chord profile made from plastic and a U-shaped lower chord profile. To absorb stresses, there is also a piece of prestressing steel laminated within the chord profile which has exposure to the greatest stresses arising from the design. In the case of very large spans, the prestressing steel can be secured to the area of perimeter support of the lightweight plastic structural element.

U.S. Pat. No. 3,770,545 also discloses an externally applicable shock-absorbant structure and a process for producing the same. There is a channel-shaped metallic element filled with vinyl material, and a vinyl bumper applied to the outer surface of the channel-shaped element. Adhesive tape is used to secure the structure to a surface.

EP 0 370 342 B1 discloses lightweight components which are composed of a concave base whose interior has reinforcement ribs which have been securely connected to the base. The base is ideally composed of metal, and the reinforcing ribs of molded-on thermoplastic. The reinforcing ribs have been connected securely to the base at discrete sites via perforations in the base, the plastic flowing through these perforations during injection molding.

This process is very complex and requires high levels of mold maintenance. For this reason it is often impossible to avoid a high proportion of rejects. In addition, each new version of, or change in, a model necessitates a new and mostly complicated injection mold. This again increases the cost of the process. Mass production is therefore often associated with unpredictable risks.

When the load is relatively high, furthermore, and when compared with the abovementioned composite components, given identical dimensioning of cross sections and comparable component weight, these components have the disadvantage of lower stiffness, in particular under torsional stress, and the disadvantage of lower energy absorption when subjected to impact. These disadvantages are primarily the result of the tendency of concave sheets to buckle once a critical load has been exceeded. The tendency toward buckling is increased if the highly stressed connection sites between the concave base and the reinforcing ribs break apart when the load increases.

It is an object of the present invention, in the light of the prior-art solutions described, to provide a composite component which does not have the abovementioned disadvantages, in particular with respect to strength properties and stiffness properties, and also with regard to energy absorption, and which permits a high level of functional integration, involving the formation of systems or modules, with cost-effective manufacture.

We have found that this object is achieved in that a composite component made from a base, which has a hollow-profile cross section, and from at least one plastic element which has been securely connected to the hollow-profile base, where the plastic element has been molded onto the hollow-profile base and its connection to the hollow-profile base takes place at discrete connection sites by partial or complete jacketing of the hollow-profile base at the connection sites by the molded-on plastic for the plastic element.

The secure connection between the hollow-profile base and the plastic elements may advantageously be achieved by completely jacketing the hollow profile with the molded-on plastic over the entire length of the hollow profile or at discrete sites on the hollow profile. In another embodiment, the connection may be achieved at discrete deformed sites, such as fillets, protrusions, or flattenings, on the hollow-profile base, in that the molded-on plastic jackets these sites to some extent or completely and/or penetrates through perforations in the flattenings and extends over the surfaces of the perforations.

Depending on the conditions of loading and installation, or the application, the hollow-profile base may be composed of one or more non-deformed or deformed or bent tubes, and may have a variety of cross-sectional shapes. Circular, elliptical, rectangular, triangular, or trapezoidal cross sections and other geometrical shapes are possible, and it is possible to create various cross-sectional shapes within a hollow-profile base, including the abovementioned deformations at the connection sites. The hollow-profile cross section, i.e. the distance between opposite walls of the tube, should generally be as large as possible, and the wall thickness as small as possible. These hollow-profile bases may be composed of galvanized or non-galvanized steel, aluminum, or magnesium, for example, and be manufactured using known processes for bending and jointing.

Hollow-profile bases with more complex shape may be produced cost-effectively by the hydroforming process (HF).

HF technology is known per se to the skilled worker, and an example of a description is found in “Handbuch der Umformtechnik”, Schuler GmbH, ed. Springer-Verlag, Berlin, 1996, pp. 405-432, and also in the publication by F. Dohmann, “Innenhochdruckumformen” in “Umformtechnik—Handbuch für Industrie und Wissenschaft”, Vol. 4, 2^{nd} edn., ed. K. Lange, Springer-Verlag, Berlin, pp. 252-270.

The original hollow profiles may be produced by various procedures, e.g. by extrusion, drawing, or straight bead welding.

Hollow profiles may also be manufactured from at least two concave, preferably metallic sheets, by stamping and deep-drawing to shape these sheets and then joining them by spot-welding, riveting, or any other method of operation, to give the hollow profile. Hollow profiles thus produced may then likewise have their shape altered by hydroforming, and be provided with final shaping specifically appropriate to the intended application.

For the hollow-profile base, use may in principle also be made of plastic tubes reinforced with glass fibers, with carbon fibers, or with synthetic fibers. These can be produced by the filament winding process, using continuous-filament fiber rovings coated with plastic, or by extrusion using fiber-reinforced thermoplastics.

Plastic elements which may be used are injection moldings made from thermoplastic polymers.

Suitable thermoplastic polymers are any of the semicrystalline or amorphous thermoplastics known to the skilled worker, examples being described in Kunststoff-Taschenbuch, ed. Saechtling, 25^{th} edition, Hanser-Verlag, Munich, 1992, particularly chapter 4 and references given therein, and in Kunststoff-Handbuch, ed. G. Becker and D. Braun, Volumes 1-11, Hanser-Verlag, 1966-1996.

Examples which may be mentioned as suitable thermoplastics are polyoxyalkylenes, such as polyoxymethylene, e.g. Ultraform® (BASF AG), polycarbonates (PC), polyesters, such as polybutylene terephthalate (PBT) or polyethylene terephthalate (PET), polyolefins, such as polyethylene (PE) or polypropylene (PP), poly(meth)acrylates, e.g. polymethyl methacrylate (PMMA), polyamides, such as nylon-6, e.g. Ultramide® B (BASF AG), or nylon-6,6, e.g. Ultramid® A (BASF AG), vinylaromatic (co)polymers, such as polystyrene, syndiotactic polystyrene, impact-modified polystyrene, such as HIPS (High-Impact Polystyrene), or SAN polymers, ASA polymers, ABS polymers, or AES polymers, polyarylene ethers, such as polyphenylene ethers (PPE), polyphenylene sulfides, polysulfones, polyether sulfones, polyurethanes, polylactides, halogenated polymers, polymers containing imide groups, cellulose esters, silicone polymers, and thermoplastic elastomers. It is also possible to use mixtures of various thermoplastics as materials for the plastic moldings. These mixtures may be single- or multiphase polymer blends.

Preferred polymer mixtures are based on PPE/HIPS blends, ASA/PC blends, ASA/PBT blends, ABS/PC blends, ABS/PBT blends, or PC/PBT blends.

The plastic moldings may moreover comprise conventional additives and processing aids.

Examples of suitable additives and processing aids are lubricants, mold-release agents, rubbers, antioxidants, light stabilizers, antistatics, flame retardants, fibrous or pulverulent fillers, fibrous or pulverulent reinforcing agents, and also other additives and mixtures of these.

Examples which may be mentioned of fibrous or pulverulent fillers and fibrous or pulverulent reinforcing materials are carbon or glass fibers in the form of glass fabrics, glass matts, or glass silk rovings, chopped glass, and also glass beads. Particular preference is given to glass fibers. The glass fibers used may be made from E, A or C glass, and have preferably been provided with a size, e.g. one based on epoxy resin, on silane, on aminosilane, or on polyurethane, and a coupling agent based on functionalized silanes. The glass fibers incorporated may either be in the form of short glass fibers or else in the form of continuous-filament strands (rovings).

Examples of suitable particulate fillers are carbon black, graphite, amorphous silica, whiskers, aluminum oxide fibers, magnesium carbonate, chalk, powdered quartz, mica, bentonites, talc, feldspar, and in particular calcium silicates, such as wollastonite, and kaolin.

The plastic moldings may moreover comprise colorants or pigments.

It is preferable for the abovementioned additives, processing aids, and/or colorants to be mixed in an extruder or in any other mixing apparatus at from 100 to 320° C. with melting of the thermoplastic polymer, and discharged. It is particularly preferable to use an extruder, in particular a corotating, tightly intermeshing twin-screw extruder. In other respects, processes for producing plastic elements are well known to the skilled worker.

One way of producing the composite components of the invention is to insert the prefabricated hollow-profile base in an injection mold with appropriately shaped mold cavity, and mold-on the plastic elements.

The hollow-profile base may also be filled with a preferably liquid medium and exposed to internal pressure. This permits calibration of the hollow-profile base, increasing its precision of fit within the mold cavity, and any local inward buckling or similar deformation within the base can be eliminated by the injection pressure within the cavities of the plastic elements.

As an alternative for metallic hollow-profile bases, a particular process combines the HF process with the injection-molding process. A brief description follows of the hydroforming/injection-molding process, abbreviated to HFI. The HFI process uses a novel HF/injection-molding machine in which the equipment for hydroforming of the hollow-profile base has been combined with the functional units for injecting and shaping the plastic elements, also termed HFI mold below.

An example of this machine is a modified injection-molding machine supplemented with equipment for carrying out the HF process. The function of the injection mold has also been extended and designed so as to permit the use of the HF process for forming the hollow-profile base prior to the injection-molding procedure. In one embodiment, the means of carrying out the HF process is that a non-deformed or deformed hollow profile is placed between the two halves of an appropriately designed HFI mold, initially still open. Closing of the HFI mold then brings the base to its final shape in a manner analogous to the HF process. The next step injects the plastic elements. Where appropriate, the creation of the cavities for the plastic elements may be delayed until immediately prior to the injection of the plastic, using movements of the core and slide in the HFI mold.

In another embodiment, a non-deformed or deformed hollow profile is inserted into the HFI mold, and the mold is closed and completely or partially filled with molten plastic. Before the charging of material to the injection-moldling cavity has ended, or else thereafter, while the plastic is molten, the hollow-profile base is exposed to internal fluid pressure, as in the HF process. When cavities are completely filled with melt, an opportunity is provided for discharge of melt.

The embodiment described above can give composite components with particularly positive interlocking.

In particular applications, the hollow-profile base may be assembled from two or more separate hollow profiles, forming contact sites or nodes. In order to obtain secure contacts at the contact sites or nodes, the adherends may be connected either with the aid of fittings, e.g. T pieces, directly during the HF procedure, or welded subsequently in a known manner. As an alternative, it is possible for two hollow profiles which overlap one another at their intersection and which have been pressed flat at that location to be connected to one another by punched riveting. In another method similar to punched riveting, the manner of creating the connection is that, instead of the rivet, the molded-on plastic fills the perforation and also extends across the surfaces of the perforations, or also jackets the two flattened tubes at nodes.

At least some portion of the metallic hollow-profile base preferably has a covering layer made from plastic. This serves as corrosion protection and as slip layer which promotes the forming of the hollow-profile base during the HF process.

The invention is described in more detail below using the drawing.

FIG. 1 shows a composite component and a connection between plastic element and hollow-profile base via complete jacketing of the hollow profile at the connection site with plastic.

FIG. 2a shows the connection between plastic element and hollow-profile base via partial jacketing of the hollow profile at the connection site with plastic and with a point of anchoring at a flattening.

FIG. 2b shows the connection between plastic element and hollow-profile base via partial jacketing of the hollow profile at the connection site with plastic and with a point of anchoring at a fillet and a protrusion.

FIG. 3a shows the connection between plastic element and hollow-profile base at flattenings and perforations in the hollow-profile base.

FIG. 3b shows the connection between plastic element and hollow-profile base at flattenings and perforations in the hollow-profile base, with complete jacketing of the hollow profile at the connection site with plastic.

FIG. 4a shows the node connection between two hollow profiles.

FIG. 4b shows a node connection as in FIG. 4a with complete jacketing of both hollow profiles at the connection site with plastic.

FIG. 1 shows a composite component and a connection between plastic element and hollow-profile base via complete jacketing of the hollow profile at the connection site with plastic.

Examples of these composite components are a front-end module or a door-function module for a car. The hollow-profile base 1 is composed of a thin-walled hollow profile made from metal. The hollow profile, produced and curved by the HF process, has a right-angled cross section with rounded corners. An example of a material used for the plastic element 2 molded onto the hollow-profile base 1 is glass-reinforced nylon-6. The plastic element 2 completely jackets the hollow-profile base 1 at the connection site. The jacket 3 generally shrinks onto the hollow-profile base 1 as a result of the shrinkage of the plastic on cooling and solidification. This results in a secure connection between the hollow-profile base 1 and the plastic element 2. The ribs 4 arranged at the connection site improve the transfer of forces between the hollow-profile base 1 and the plastic element 2, and thus reduce the stresses in this critical region.

FIGS. 2a, 2b, 3a and 3b show other possibilities for connecting hollow-profile base 1 to a plastic element 2. The points of anchoring are the result of deformation introduced at discrete sites within the hollow-profile base 1. In the case of the connection in FIG. 2a, the hollow-profile base 1 has a discrete flattening 5 which is created by local flattening of the hollow-profile base 1. The secure connection between the hollow-profile base 1 and the plastic element 2 is the result of the jacketing 6, emanating from the plastic element 2, of the flattening 5 and of the neighbouring surfaces of the hollow-profile base 1 which face toward the plastic element. The fact that the plastic jacket 6 shrinks onto the hollow-profile base 1 at the connection site is utilized here. The points of anchoring in FIG. 2b are the result of fillets 5a and protrusions 5b, in each case encapsulated by the plastic walls 6a, 6b supplied by the plastic element. The plastic ribs 7 arranged at the connection site serve to stiffen and reinforce the connection and of the plastic element.

In the case of the two connections of FIGS. 3a and 3b, the hollow-profile base 1 likewise has a discrete flattening 8, created by local pressure-flattening, with an added perforation 9. The plastic molded on for the plastic element 2 penetrates the hollow-profile base 1 within the perforation 9, and extends 10 across the surfaces of the perforation 9, so that the hollow-profile base 1 becomes covered with plastic in the region of the flattening 8 and the adjacent zones 10, as shown in FIG. 3a. In contrast to this, the hollow-profile base 1 may have been completely jacketed with a plastic wall 12 in the region of the connecting site, as can be seen in FIG. 3b. The plastic ribs 11 serve to reinforce and stiffen the connection and the plastic element.

FIGS. 4a and 4b show the node connection between two intersecting hollow profiles of a hollow-profile base. The two hollow profiles 1a and 1b have been flattened at the intersection, and lie directly upon one another at this site. Within the pressed-flat region of overlap 12, each of the two hollow profiles 1a and 1b has a perforation 14. The perforations 14 in the two hollow profiles 1a and 1b have been aligned with one another, and the margin of each has a collar 13, produced during stamping-out of the perforations 14. The result is preliminary securing of the two hollow profiles 1a and 1b at the point of intersection. The node connection is secured by the molded-on plastic 2, in that the plastic penetrates the two hollow profukes 1a and 1b within the perforation 14 and extends across the surface of the perforation 14 so that the two hollow profiles 1a and 1b have been surrounded by plastic walls 15 in the region of the flattening 12, as in FIG. 4a. As an alternative, the two hollow profiles 1a and 1b may, as can be seen from FIG. 4b, have been completely jacketed by the molded-on plastic wall 17 at the point of intersection. Ribs 16 made from plastic may be molded on to stiffen and reinforce the node connection.

One possible sequence for the HFI process starts with the positioning of the non-deformed or deformed hollow-profile base between two halves of the open HFI mold which has been installed in the HFI machine in advance as known from injection molding. At this stage it is preferable that the interior of the hollow-profile base is filled with a liquid, e.g. water, and that the pressure is increased. The magnitude of the pressure depends on the material and on the shape of the base. The next step is the closing of the HFI mold by converging the two mold halves. Where appropriate, the extremities of the hollow-profile base are made to follow this movement. This method produces the final shape of the hollow-profile base in a manner similar to the HFI process. The plastic is then injected into the cavities provided for the plastic elements in the HFI mold. Depending on the design of the composite component, it may be necessary to execute core movements and slide movements in the HFI mold in advance in order to make cavities available for the plastic elements. For the forming of the hollow-profile base, these cavities also have to be sealed. During the cooling and solidification of the plastic elements, the reduction of pressure in the hollow-profile base takes place, and is followed by its removal. In the last step of the process, the HFI mold opens and, as in injection molding, the composite component is ejected or removed with the aid of a gripper. The HFI cycle then begins afresh.

Examples of applications of the composite components of the invention are found in automotive construction. Particularly suitable uses of the composite components include structural components for bodywork, such as front-end supports, front-end modules, door-function supports, door modules, and similar components for tailgates, seats, seat elements, or seat shells, and components for dashboards and instrument panels.

These composite components are also used as components in piping, e.g. in the sanitary sector, in the construction industry, or in the construction of motor cycles or pedal cycles, i.e. in particular wherever there is a need to realise complex component shapes in a manner which is reliable and cost-effective.

The combination of injection-molding technology and HF technology in one mold for producing hybrid lightweight components permits not only a reduction in the cost of apparatus and process technology, e.g. the number of molds and steps in the process, but also a drastic reduction in cycle times.

Key

1 Hollow-profile base

1a Hollow profile

1b Hollow profile

2 Plastic element

3 Connection site

4 Plastic rib

5 Flattening

5a Fillet

5b Protrusion

6 Point of anchoring at flattening

6a Point of anchoring at fillet

6b Point of anchoring at protrusion

7 Plastic rib

8 Flattening

9 Perforation

10 Point of anchoring at flattening with perforation

11 Plastic rib

12 Plastic wall/plastic jacketing

13 Collar

14 Perforation

15 Plastic wall

16 Plastic rib

17 Plastic jacketing

We claim:

1. A composite component made from a metallic hollow-profile base (1) which has a hollow-profile cross section, and from at least one plastic element (2) which has been securely connected to the hollow-profile base (1), wherein the plastic element (2) has been molded onto the hollow-profile base (1) and its connection to the hollow-profile base (1) takes place at discrete connection sites (3, 6) by partial or complete jacketing of the hollow-profile base (1) at two or more connection sites (3, 6, 6a, 6b, 10, 12) by the molded-on plastic for the plastic element (2).

2. A composite component as claimed in claim 1, wherein the hollow-profile base (1) has flattenings (5, 8), fillets (5a), protrusions (5b), or similar deformations at the connection sites, so that the molded-on plastic produces points of anchoring (6, 6a, 6b, 10) between the hollow-profile base (1) and the plastic element (2).

3. A composite component as claimed in claim 1 or 2, wherein, in the region of the connection site, the hollow-profile base (1) has a flattening (8) with at least one perforation (9) through which the molded-on plastic penetrates and extends over the surfaces of the perforations (10).

4. A composite component as claimed in claims 1, 2, or 3, wherein the hollow-profile base (1) is composed of at least two hollow profiles and at the nodes where two hollow profiles (1a, 1b) meet both have been flattened and provided with mutually aligned perforations (14) through which the injected plastic penetrates and extends over the surfaces of the perforations (15).

5. A composite component as claimed in any of claims 1 to 4, wherein, at the intersection of the two hollow profiles (1a, 1b), the base composed of two hollow profiles (1a, 1b) has been encapsulated completely with walls (17) of the molded-on plastic.

6. A composite component as claimed in any of claims 1 to 5, wherein the margins of the perforations (9, 14) have deformations (13).

7. A composite component as claimed in any of claims 1 to 6, wherein, at the sites of connection to the hollow-profile base (1) and at the intersections of two adjacent hollow profiles, the plastic element (2) has ribs (4, 7, 11, 16) for the reinforcement and stiffening of the anchoring point and of the plastic element (2).

8. A composite component as claimed in any of claims 1 to 7, wherein at least some part of the metallic hollow-profile base (1) has a covering layer made from plastic.

9. A composite component as claimed in any of claims 1 to 8, wherein the ideally metallic hollow-profile base (1) is produced by hydroforming.

10. A composite component as claimed in any of claims 1 to 9, wherein the hollow-profile base (1) is manufactured from at least two concave, ideally metallic sheets which are formed in advance by stamping and/or deep-drawing and then are joined by spot welding or riveting or any other process to give the hollow-profile base (1).

11. A process for producing a composite component as claimed in any of claims 1 to 10, which comprises using the steps of hydroforming of the hollow-profile base (1) in combination with the injection-molding steps for the molding-on and shaping of the plastic elements (2), so that the forming of the hollow-profile base (1) and the injection molding of the plastic elements (2) can take place on the same HF injection-molding machine.

12. A process as claimed in claim 11, wherein the hollow-profile base is inserted into the mold of the HFI injection-molding machine, the mold is closed, and HF technology is used to bring the hollow-profile base to the shape prescribed by the mold cavity, and the plastic elements are molded onto the hollow profile, where appropriate after creating one or more cavities, and the composite component is removed from the mold.

13. A process as claimed in claim 11, wherein the hollow-profile base is inserted into the mold of the HF injection-molding machine, the mold is closed, and molten plastic is charged to the cavity of the injection mold, and, during or after the charging process, while the plastic is molten, HF technology is used to bring the hollow-profile base to the shape prescribed by mold and melt, and the composite material is removed from the mold.
